(19) United States
(12) Patent Application Publication
(10) Pub. No.: US 2024/0010171 A1
(43) Pub. Date: Jan. 11, 2024

(54) Heating mechanism for a cover element of a sensor assembly, sensor assembly, roof module and motor vehicle

(71) Applicant: Webasto SE, Stockdorf (DE)

(72) Inventors: Bernhard SCHIEDER, Stockdorf (DE); Roman Georg SCHEMMERER, Stockdorf (DE); Philipp WAGENKNECHT, Stockdorf (DE)

(21) Appl. No.: 18/218,323

(22) Filed: Jul. 5, 2023

(30) Foreign Application Priority Data
Jul. 8, 2022 (DE) 10 2022 117 096.9

(51) Int. Cl. B60S 1/56; B60S 1/02; H05B 3/84

(52) U.S. Cl. CPC B60S 1/56; B60S 1/023; H05B 3/84

(57) ABSTRACT

A heating mechanism for a cover element of a sensor assembly, the heating mechanism may have a plurality of electrically connected conductor paths applied to a backing film and/or a heating film applied to the backing film. The heating mechanism may have at least one electrical push-through contacting element, which has a film contact portion and a connection contact portion, and a counter-contact element, the film contact portion being electro-conductively connected to at least one of the plurality of conductor paths and/or the heating film, the connection contact portion being inserted through the backing film and protruding relative to the backing film, and the counter-contact element being attached to the connection contact portion so that the film contact portion is counter-secured relative to the counter-contact element with at least the backing film interposed, and the connection contact portion being configured to be connected to a terminal of an electrical source.

### CROSS-REFERENCE TO RELATED APPLICATION

This application claims priority from German Patent Application Number 10 2022 117 096.9, filed on Jul. 8, 2022, which is hereby incorporated herein by reference in its entirety for all purposes.

### FIELD

The invention relates to a heating mechanism for a cover element of a sensor assembly having the features of the preamble of claim 1. Furthermore, the invention relates to a sensor assembly comprising a cover element and such a heating mechanism. The invention also relates to a roof module comprising such a sensor assembly and to a motor vehicle comprising at least one such sensor assembly and/or at least one such roof module.

### BACKGROUND

A sensor assembly is known from practice and can be used in a motor vehicle for monitoring a vehicle environment. For this purpose, the sensor assembly comprises a sensor element that emits electromagnetic radiation, for example in the form of laser radiation, in one or more specific directions so that the vehicle environment, including the course of the road, the traffic situation and the like, can be detected and processed by a system of the vehicle. The sensor element is disposed, for example, in a roof area of the vehicle or also in the area of the vehicle front or front end and positioned behind a cover element, which is transparent to the electromagnetic radiation emitted by the sensor element. The cover element can be made of a plastic material. In order to keep the cover element transparent to the electromagnetic radiation even in bad weather conditions and to be able to de-ice it, a heating mechanism known per se can be provided, which comprises conductor paths or a surface heating layer, which are disposed on the inner side of the cover element, which faces the sensor element. Sensor assemblies of this kind are known, for example, from DE 10 2018 109 884 A1 and WO 2021/032599 A1.

Roof modules are also already used extensively in vehicle manufacturing since these roof modules are prefabricated as separate functional modules and can be delivered to the assembly line when assembling the vehicle. The roof module at least partially forms a roof skin of the vehicle roof on its outer surface, the roof skin preventing moisture or air flows from entering the vehicle interior. The roof skin is composed of one or more panel components, which can be made of a stable material, such as painted metal or painted or solid-colored plastic. The roof module can be a part of a rigid vehicle roof or a part of an openable roof assembly.

Furthermore, the development in vehicle construction is increasingly directed towards autonomously or semi-autonomously driving motor vehicles. To enable the vehicle control system to control the vehicle autonomously or semi-autonomously, a plurality of sensor elements, in particular environment sensors (e.g., lidar sensors, radar sensors, (multi-) cameras, etc., including other (electrical) components) are used, which are integrated into the roof module, detect the environment surrounding the vehicle and use the detected environmental data to determine, for example, a current traffic situation. Roof modules equipped with a plurality of environment sensors are also known as roof sensor modules (RSM). The known environment sensors transmit and/or receive electromagnetic signals, such as laser beams or radar beams, allowing a data model of the vehicle environment to be generated by signal evaluation and used for controlling the vehicle.

The environment sensors for monitoring and detecting the vehicle environment are usually disposed on the vehicle roof since the vehicle roof is usually the highest point of a vehicle, from where the vehicle environment is easily visible. The sensor modules are placed on top of the panel component of the roof module, which forms the roof skin, as attachments. During the use of the environment sensor, there is a risk due to environmental influences, such as ice formation, that a see-through area partially transparent or transparent to the environment sensor becomes covered by ice and thus a signal detection of the environment sensor is disturbed and, in the worst case, becomes completely opaque. For this reason, the de-icing of the see-through area, for example by using a cover element with a heating mechanism, is known.

In the course of further development in the field of integration of such heating mechanisms, in particular heating films, however, the problem of an insufficient contacting possibility when connecting or integrating such a heating mechanism into an electrical circuit has emerged. In particular, the heating mechanism in the prior art is injection-overmolded with and/or integrated into a plastic layer, such as a transparent polycarbonate (PC) layer, as flat heating films in the course of an injection molding process. After the heating mechanism has been injected or after the cover element, which is an injection-molded part, has been formed, it is necessary in the prior art to expose the electrical contact areas of the heating mechanism again since they are covered by a plastic layer as a result of the injection molding process. This requires a high degree of precision since the underlying conductor paths, which are used for electrical contacting, are often very thin, for example only about 0.4 mm thick.

Alternatively, for the integration of a heating mechanism in a plastic component designed as a cover element, it is known to make use of heating films whose backing film(s) comprise, for example, PET, PS or polycarbonate or another engineering plastic. The heating films can be permanently bonded to the cover element (i.e., the substrate) by lamination or in-mold lamination. One challenge, in addition to creating a bond as homogeneous as possible between the heating film and the substrate, is the integration of an electrical terminal. The terminal is used to connect the heating film or the heating mechanism to an electrical power source via a plug or another type of contacting device. In this context, it is preferred for the heating mechanism integrated in or disposed on the cover element to be contacted as quickly and reliably as possible for putting it into operation so that it can be operated without malfunctions over the long term.

For this purpose, plug integrations and/or electrical contacting devices have been known on the market, which have to be manufactured using a complex production process. For instance, the known plug integrations and/or contacting devices often require complex semi-finished products, which additionally have to be attached to a cover element in question with the aid of complex tooling technology. For example, it is known to first produce a separate plug insert by injection molding, which has to be injected into the cover element as a semi-finished product during the actual production process of the cover element. This makes the production of such cover elements complex and expensive. Moreover, the state of the art requires the production or provision of an electrical connection of the plug and/or the contacting device with a bus bar, through which the conductor paths are electro-conductively connected to each other. Likewise, the known plug integration and/or contacting device can only take place in non-visible areas of a motor vehicle, i.e., at concealed locations since otherwise a strong outlining of the plug and/or the contacting device would be visually disadvantageous.

### SUMMARY

Due to the aforementioned disadvantages and problems, it is an object of the invention to propose an enhanced heating mechanism and/or a sensor assembly which at least reduce the aforementioned problems and disadvantages and in particular improve an electrical contacting of a heating mechanism.

The object is attained by a heating mechanism having the features of claim 1. Furthermore, the object is attained by a sensor assembly having the features of claim 10. Likewise, the object is attained by a roof module according to claim 14, which comprises at least one such sensor assembly, and by a motor vehicle according to claim 15, which comprises at least one sensor assembly according to the invention and/or at least one such roof module.

Advantageous embodiments of the invention are the subject matter of the dependent claims. Any and all combinations of at least two features disclosed in the description, the claims, and/or the figures fall within the scope of the invention. Naturally, the explanations given in connection with the heating mechanism equivalently relate to the sensor assembly according to the invention and/or the roof module according to the invention and/or the motor vehicle without being mentioned redundantly in its/their context. In particular, linguistically common rephrasing and/or an analogous replacement of respective terms within the scope of common linguistic practice, in particular the use of synonyms backed by the generally recognized linguistic literature, are of course comprised by the content of the disclosure at hand without every variation having to be expressly mentioned.

According to the invention, a heating mechanism for a cover element of a sensor assembly is proposed, the heating mechanism comprising a plurality of electrically connected conductor paths applied to a backing film and/or a heating film applied to the backing film, characterized in that the heating mechanism comprises at least one electrical push-through contacting element, which has a film contact portion and a connection contact portion, and a counter-contact element, the film contact portion being electro-conductively connected to at least one (preferably several) of the plurality of conductor paths and/or the heating film, the connection contact portion being inserted through the backing film and protruding relative to the backing film, in particular in a direction opposite to the measuring direction mentioned below, and the counter-contact element being attached to the connection contact portion in such a manner that the film contact portion is counter-secured relative to the counter-contact element with at least the backing film interposed, and the connection contact portion being configured to be connected to a terminal of an electrical power source.

In its intended use, the heating mechanism is preferably configured to be integrated in a cover element of a sensor assembly or to be disposed on such a cover element, for example to be laminated thereon. Thus, the invention does not relate to heating mechanisms that are not intended for such arrangement on a cover element. It is also understood that the aforementioned terminal of an electrical power source is not directly part of the protected heating mechanism, but that the heating mechanism, in particular the connection contact portion, is suitable to be connected to a terminal of an electrical power source. Such a terminal of an electrical power source is especially preferably complementary to the connection contact portion so that it can be electro-conductively connected thereto according to a plug-socket principle.

The phrasing “[ . . . ] film contact portion is counter-secured relative to the counter-contact element with at least the backing film interposed [ . . . ]” means that by applying the counter-contact element to at least a part of the connection contact portion, at least the backing film, but possibly also further layers, is clamped between the film contact portion and the counter-contact element. The film contact portion preferably comprises a shoulder area, i.e., an area protruding radially relative to the connection contact portion, said area comprising an annular surface which is in direct or indirect contact with the backing film when the push-through contacting element is inserted through the backing film. Particularly preferably, the backing film comprises a hole or an opening through which the push-through contacting element can be inserted. The hole or opening preferably has a circular diameter substantially (i.e., within a predetermined tolerance limit) corresponding to an outer diameter of the connection contact portion. The heating film is preferably a flat heating element. For example, the heating film can be applied to the backing film as a heating layer and/or a heating surface and/or a heating coating. The heating film preferably forms the heating layer and/or the heating surface and/or the heating coating. In principle, an embodiment without an additional backing film is also conceivable. In other words, it is possible for the heating film to form or comprise the backing film.

The push-through contacting element is particularly preferably manufactured by a 3D printing process. The push-through contacting element is preferably designed as a hollow rivet. The hollow rivet can preferably be printed by metallic, in particular copper-based, 3D printing. This allows even complex shaping of the push-through contacting element without sacrificing electrical conductivity.

The heating mechanism according to the invention has the advantages that the push-through contacting element can preferably be manufactured at low cost and still enables stable and secure contacting of the heating mechanism through a terminal of an electrical power source. The design according to the invention also makes it possible to readjust the push-through contacting element, for example to compensate for deviations in the cover element caused by production. Furthermore, the push-through contacting element offers a solder- and adhesive-free solution and can thus be manufactured more simply and cost-efficiently than in the state of the art. In other words, according to the invention, the at least one contact in the form of the push-through contacting element is connected indirectly or directly to the backing film by inserting and counter-securing without the need to create a semi-finished product and can be placed on, embedded in or integrated into a cover element together with the backing film in a lamination or injection molding or in-mold lamination process.

In a preferred embodiment, the film contact portion is indirectly electro-conductively connected to the plurality of conductor paths and/or the heating film with a contacting surface, in particular a bus bar contacting surface, interposed. A bus bar is preferably an arrangement of electrical conductors serving as a central distributor of electrical energy since all incoming and outgoing conductor paths are connected to the bus bars.

In a preferred embodiment, the push-through contacting element has the shape of a hollow rivet. The film contact portion preferably forms a rivet head. The connection contact portion preferably forms a tubular rivet shank. Preferably, an inner wall of the tubular connection contact portion is configured to receive a terminal of an electrical power source. The terminal or the plug connection of the electrical power source is preferably dimensioned and/or formed complementary to the connection contact portion. The rivet shank is preferably hollow in its interior, thus also tubular, so that the terminal can preferably be inserted into this cavity. In particular, this design has the advantage over a pin-like design of a contact element that a plug and/or a plug connection and/or a terminal can be connected to a power source in a simple manner. After all, a terminal can preferably be accommodated in the cavity of the rivet shank. This simplifies the connection process significantly. If the contact were pin-shaped on the other hand, a terminal would have to be attached to an outer wall surface of the contact pin, which is disadvantageous compared to a plug-in connection.

In a preferred embodiment, an outer diameter of the film contact portion is greater than an outer diameter of the connection contact portion. This embodiment merely specifies that the film contact portion comprises a shoulder which protrudes radially relative to the connection contact portion and which serves to ensure that the push-through contacting element cannot be inserted completely through an opening in the backing film, but only the connection contact portion can be inserted through this opening, whereas the film contact portion cannot be inserted through the opening due to its dimensions. The film contact portion thus serves as a counter-securing feature for the backing film when the counter-contact element is disposed on the connection contact portion.

In a preferred embodiment, the counter-contact element is screwed and/or hooked and/or snap-locked and/or clamped to the connection contact portion. In principle, other types of connection between the counter-contact element and the connection contact portion are also possible. Particularly preferably, the counter-contact element can be brought into engagement with the connection contact portion in a reversible manner.

In a preferred embodiment, the counter-contact element is in particular substantially sleeve-shaped. Particularly preferably, the counter-contact element is tubular. In other words, the counter-contact element preferably has the shape of a sleeve or a tube, but can also comprise a thread, in particular an internal thread and/or one or more hooks and/or projections and/or notches for fastening purposes.

Particularly preferably, two counter-contact elements can also be provided, one of the two counter-contact elements being configured to inhibit the other counter-contact element from coming loose. So the one counter-contact element preferably serves as a securing device for the other counter-contact element.

In a preferred embodiment, at least part of the connection contact portion comprises an external thread and at least part of the counter-contact element comprises an internal thread corresponding to the external thread. Particularly preferably, the counter-contact element is screwed onto the connection contact portion in such a manner that an annular sleeve edge, in particular the aforementioned shoulder, of the counter-contact element is in contact with the backing film or with a cover layer applied to the backing film. The cover layer can be part of the cover element, for example, if the backing film is integrated or embedded in it. Alternatively, the cover layer can be a protective coating applied to the backing film, for example by injection molding or a coating process. Alternatively, the cover layer can be a coating on the backing film itself, the coating serving to increase a mechanical stability of the backing film, for example.

In a preferred embodiment, the connection contact portion comprises at least one catch groove and/or one catch web on the outside (preferably on an outer well surface of the hollow rivet). The counter-contact element comprises a catch web corresponding to the catch groove and/or a catch groove and/or a catch shoulder corresponding to the catch web on the inside (preferably on an inner wall surface of the sleeve), by means of which the counter-contact element is counter-secured to the connection contact portion. Particularly preferably, in this embodiment, another counter-contact element can be disposed on the connection contact portion to prevent the snap-locked counter-contact element against being lost. The other counter-contact element can be screwed onto a threaded portion of the connection contact portion by means of a corresponding counter-thread, for example.

In a preferred embodiment, the connection contact portion comprises at least one catch groove and/or guide groove and/or one catch web and/or one guide web on the inside (preferably on an inner wall surface of the hollow rivet) which is/are configured to be brought into engagement with a terminal of an electrical power source. A complementary catch groove and/or a complementary guide groove and/or a complementary catch web and/or a complementary guide web is preferably provided on the terminal. This ensures a secure insertion and fastening of the terminal with the connection contact portion.

In a preferred embodiment, a sensor assembly of a motor vehicle is claimed, the sensor assembly comprising a sensor element which emits and/or detects electromagnetic radiation in at least one measuring direction to obtain a measuring signal, a cover element which is disposed in front of the sensor element in the at least one measuring direction and which is transparent to the electromagnetic radiation, and a heating mechanism according to any embodiment of the invention, which is disposed on the cover element or integrated in the cover element.

The cover element preferably forms a see-through area through which the at least one sensor element can transmit and/or receive the electromagnetic radiation. The sensor element is preferably disposed in such a manner relative to and/or on the cover element that it looks through the cover element. Particularly preferably, the sensor element is configured to emit and/or receive the measuring signal in the measuring direction, which in particular defines a main measuring direction, preferably an optical axis in the case of an optical measuring element. Preferably, the measuring direction defines a main cone axis around which a cone-shaped detection field opens starting from the sensor element. A cone opening angle is preferably sensor-specific and may be manipulated, in particular enlarged or reduced, by means of an optical element, such as a lens. The at least two bus bar preferably contact the plurality of conductor paths in such a manner that the conductor paths are connected in series. If each of the bus bars is connected to a voltage source via one or more cables, for example, electrical energy can flow through the plurality of conductor paths. A portion of said electrical energy is transformed into heat, which can provide the heating effect. The heat is preferably transferred through the plastic layer to the outer side of the cover element so that ice formed thereon can be melted. Thus, the de-icing effect can be achieved.

The at least one sensor element is preferably at least a part of an environment sensor, in particular a lidar sensor and/or a radar sensor and/or a camera sensor and/or a multi-camera sensor and/or an ultrasonic sensor and/or the like. In principle, the sensor element can also comprise an antenna or a light emission module. Lidar sensors, for example, operate in a wavelength range of 905 nm or about 1550 nm. The material of the cover element, which preferably forms a see-through area through which the lidar sensor looks, is preferably transparent for the wavelength range used by the environment sensor and is therefore selected as a function of the wavelength(s) used by the environment sensor. A field of view of the environment sensor preferably extends symmetrically around the optical axis of the environment sensor in the shape of a cone with a sensor-specific cone opening angle.

In a preferred embodiment, the cover element is made of plastic, in particular a polycarbonate plastic, or glass. Particularly preferably, the cover element is manufactured by an injection molding process. Alternatively, the cover element can also be deep-drawn. The heating mechanism, in particular the backing film, can be placed on or integrated in the cover element by lamination and/or by overmolding and/or in-mold lamination and/or by integration between two plastic layers. In principle, it also seems possible to glue the backing film to a surface of the cover element. Particularly preferably, the heating mechanism, in particular the backing film, is disposed on a (inner) side of the cover element facing the sensor element. In principle, however, the heating mechanism can also be disposed on a (outer) side of the cover element facing away from the sensor element. Alternatively, it is possible that the heating mechanism is completely integrated in the cover element.

In a preferred embodiment, the backing film comprises a polycarbonate material. In principle, however, other plastics are also conceivable.

In an advantageous embodiment of the sensor assembly according to the invention, the cover element is provided with a protective coating on its outer side facing the vehicle environment in order to be able to protect the cover element from damage and wear.

The protective coating can consist of a single- or double-layer paint system that provides scratch, weather and/or chemical protection. The paint system used can be thermally curing or a paint system that cures using UV radiation. Conceivably, the paint system can be applied by a spray method or by a flood coating method.

Preferably, the protective coating has a refractive index that is smaller than that of the injection molded plastic material of the cover element. This can improve the transmission behavior of the cover element.

The sensor assembly according to the invention can basically be disposed at any location of a motor vehicle and/or a roof module and can be designed for different purposes. For example, the sensor assembly is integrated in a vehicle roof, in particular in a roof module, by which the vehicle roof is formed at least in part, and is thus preferably a component of a system for autonomous or partially autonomous driving of the vehicle in question. In this case, the cover element preferably forms an outer skin element of the vehicle roof, i.e., in particular a fixed roof portion which is immovable relative to the vehicle structure. However, it is also conceivable that the sensor assembly is disposed on a vehicle roof and/or the roof module in the manner of a dome. In this case, the cover element forms at least part of a housing of the sensor assembly, said housing accommodating the sensor element. Particularly preferably, the vehicle and/or the roof module can comprise multiple sensor assemblies and/or multiple cover elements.

In an alternative embodiment, the cover element forms an outer skin element of a vehicle front or a vehicle rear. In this case, the sensor assembly can also be part of an adaptive cruise control, a parking assistant and/or any other safety device of the vehicle in question.

In a preferred embodiment, a roof module for forming a vehicle roof on a motor vehicle is proposed, the roof module comprising a panel component at least partially forming a roof skin of the vehicle roof, the roof skin serving as an outer sealing surface of the roof module, and at least one sensor assembly according to any embodiment of the invention.

Also preferred is a motor vehicle comprising a vehicle body, at least one sensor assembly and/or at least one roof module disposed on the vehicle body as a structural unit, and an electrical power source, in particular a vehicle battery, which comprises at least one electrical terminal which is electro-conductively connected to the connection contact portion of the heating mechanism, the terminal preferably being a plug connector, particularly preferably a plug connector having a spring-loaded head, which engages the connection contact portion to electrically connect the heating mechanism to the power source.

The conductor paths can be applied to the backing film by any method. It is conceivable to use printing processes, embossing processes or transfer processes for this purpose. Specific examples include screen printing processes, dispensing processes, hot stamping processes and transfer printing processes. In addition, suitable curing processes, such as laser curing, can be used to cure the conductor paths.

When injection-molding the cover element, which is preferred, the backing film or the film blank is preferably overmolded in such a manner that the side on which the conductor paths are disposed is overmolded with the plastic material. The other side of the backing film, on the other hand, can remain free or can be coated with a protective layer, e.g., paint, made of plastic, for example.

Of course, the embodiments and the illustrative examples mentioned above and yet to be discussed below can be realized not only individually but also in any combination with each other without departing from the scope of the present invention. Moreover, any and all embodiments and illustrative examples of the equivalently or at least similarly relate to all embodiments of the invention without being separately in each instance.

### BRIEF DESCRIPTIONS OF THE DRAWINGS

Embodiments of the invention are schematically illustrated in the drawings and are discussed as examples below.

FIG. 1 is a schematic illustration of a motor vehicle comprising a roof module and an exemplary embodiment of the sensor assembly according to the invention including a heating mechanism;

FIG. 2 is a schematic illustration of a sensor assembly;

FIG. 3 is a schematic illustration of a cover element comprising a heating mechanism according to the invention;

FIG. 4 is a schematic illustration of a cover element comprising a heating mechanism according to the invention;

FIG. 5 is a schematic illustration of a cover element comprising a heating mechanism according to the invention;

FIG. 6 is a schematic illustration of a cover element comprising a heating mechanism according to the invention;

FIG. 7 is a side view and a sectional view of an exemplary embodiment of a push-through contacting element;

FIG. 8 is a schematic perspective view of the exemplary embodiment of a push-through contacting element shown in FIG. 4; and

FIG. 9 is a schematic sectional view of another embodiment of a push-through contacting element.

### DETAILED DESCRIPTION

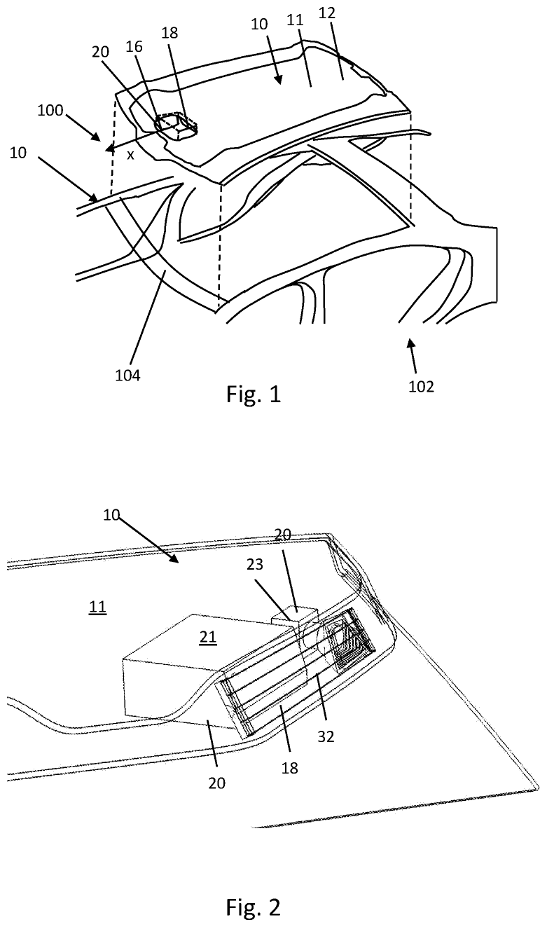

FIG. 1 shows a motor vehicle 100. A roof module 10 is disposed on a vehicle body 102, in particular on a body roof frame 104 of the vehicle body 102. The roof module 10 comprises a panel component 11 which at least partially forms a roof skin of a vehicle roof 12, the roof skin serving as an outer sealing surface of the roof module 10. The panel component 12 is, for example, an injection-molded part made of a plastic material or glass, in the present case a polycarbonate material.

The roof module 10 further comprises at least one sensor assembly 16. The sensor assembly 16 comprises a cover element 18, which preferably forms part of a sensor housing in which a sensor element 20 is disposed. In the case at hand, the cover element 18 covers an opening 19 of the panel component 11 and closes this opening 19 preferably in a moisture-proof manner against the vehicle environment (see FIG. 2). In this case, the cover element 18 forms a see-through area, in particular a window, through which the sensor element 20 looks. In the case at hand, the sensor element 20 is a lidar sensor which emits laser light in a measuring direction x and receives reflected laser light from the vehicle environment back through the see-through area. The laser light preferably passes through the cover element 18 in the form of electromagnetic signals. The lidar sensor is configured to send and/or receive the electromagnetic signals and to evaluate them, for example by means of an evaluation device 21, in such a manner that a detected vehicle environment can be reconstructed from them.

The cover element 18 comprises at least one plastic layer 22, for example made of a polycarbonate material. In the case at hand, a backing film 26 of a heating mechanism 28 is disposed on an inner side 24 of the plastic layer 22 facing the sensor element 20. In other embodiments, the backing film 26 can also be integrated into the at least one plastic layer 22.

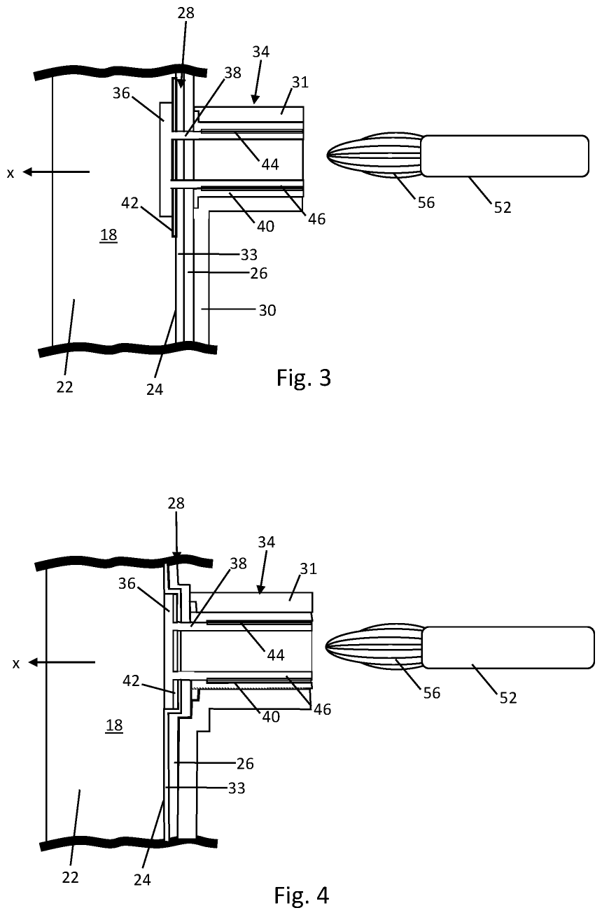

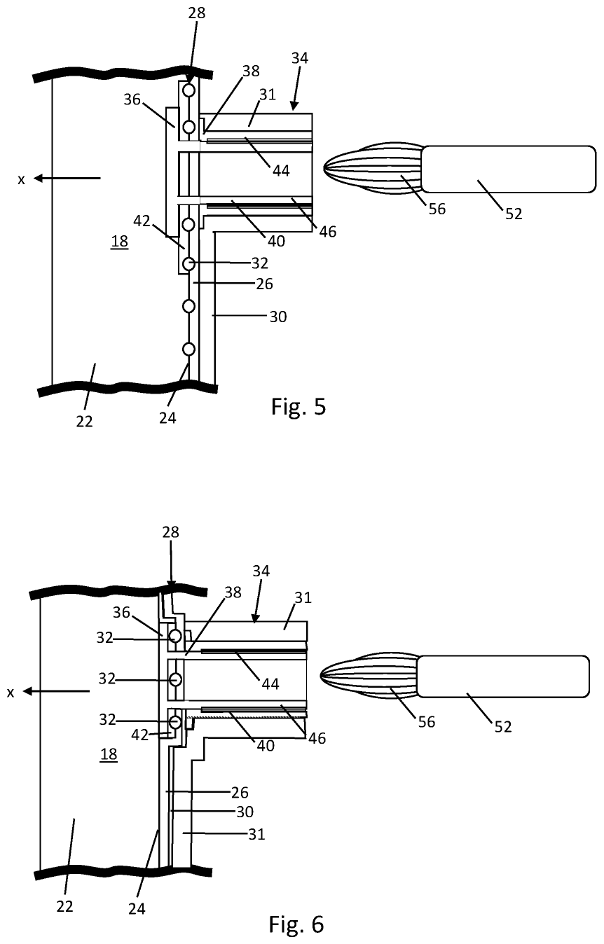

As shown in FIGS. 3, 5 and 6 by way of example, a protective coating 30 is applied to, for example sprayed on or painted on or vapor-deposited or sputtered on, the side of the backing film 26 facing the sensor element 20. In the case at hand, the protective coating 30 is a top layer. Alternatively or in addition to the protective coating 30, an additional housing 31, for example made of a two-component injection-molded plastic, can also be provided. This housing is also shown by way of example in FIGS. 3 to 6, but is of a purely optional nature. The protective coating 30 can be another plastic layer, for example, and preferably contribute to increasing the mechanical stability of the backing film 26. The plastic layer can also preferably be formed integrally with the housing 31. The backing film 26 is preferably made of a polycarbonate material. In the case at hand, the backing film 26 comprises a heating layer 33, which forms part of the heating mechanism 28 for heating the cover element 18. Alternatively, the heating mechanism 28 can also comprise a plurality of conductor paths 32, as exemplified by FIG. 5 or 6.

According to the invention, the heating mechanism 28 of the cover element 18 of the sensor assembly 16 thus comprises a plurality of electrically connected conductor paths 32, which are applied to, in particular vapor-deposited or printed on or ultrasonically applied to or embedded in, a backing film 26. The cover element 18 can also be referred to as a substrate. The heating mechanism 28 includes at least one electrical push-through contacting element 34, which has a film contact portion 36 and a connection contact portion 38, and a counter-contact element 40.

The film contact portion 36 is directly or indirectly electro-conductively connected to at least one of the plurality of conductor paths 32 or the heating layer 33. According to FIGS. 3 and 4, the film contact portion 36 is in electrically connected to the heating layer 33 with a bus bar contact surface 42 interposed so that current can be transferred to the bus bar contact surface 42 through the film contact portion and thereby to the heating layer 33. According to FIG. 5 or 6, the film contact portion 36 is electrically connected to the plurality of conductor paths 32 through the interposition of a bus bar contact surface 42, which interconnects the plurality of conductor paths, so that current transfer to the bus bar contact surface 42 and thereby to the plurality of conductor paths 32 is possible via the film contact portion. Preferably, the backing film 26 comprises two push-through contacting elements 34 according to the invention, which are preferably spaced apart from each other. The two push-through contacting elements 34 preferably form the two poles of the heating mechanism 28 so that a circuit-closing connection of the heating mechanism 28 to a power source is possible. It is understood that the inner side 24 and/or an outer side opposite to the inner side 24 can be colored.

According to the embodiment shown in FIGS. 4 and 6, the heating layer 33 and/or the backing layer 26 comprises a design in which the film contact portion 36 and/or the bus bar 42 is embedded therein. The backing film 26 and/or the protective layer 30 and/or the optional housing 31 preferably has/have an indentation in which at least the film contact portion 36 and/or the bus bar 42 can be embedded so that at least a head side of the film contact portion does not protrude over the inner side 24. In this way, a preferably flat surface is formed on the inner side 24. This is advantageous for the attachment of the cover element 18 since optical distortions can be minimized in this way, for example. It is understood that such a type of design is also possible for embedding the plurality of conductor paths 32, see FIG. 6.

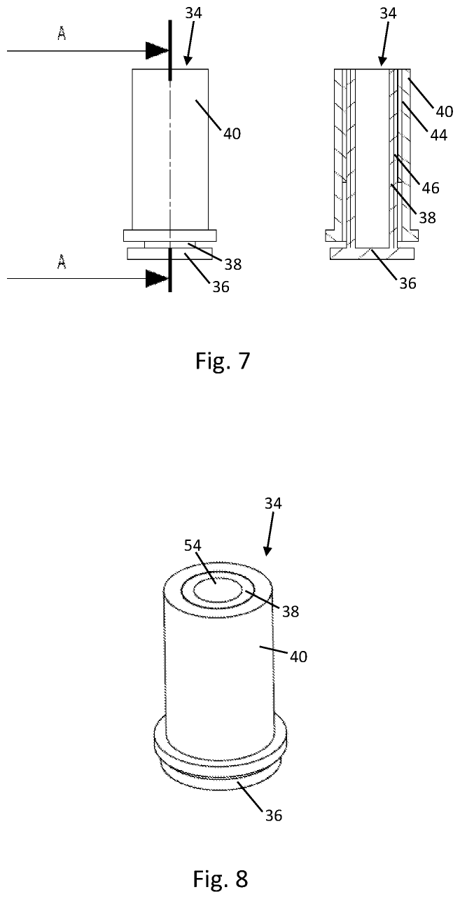

The connection contact portion 38 is inserted through the backing film 26 and thus protrudes against the measuring direction x relative to the backing film 26 (see FIGS. 3 and 5). The counter-contact element 40 is attached to the connection contact portion 38 in such a manner that the film contact portion 36 is secured relative to the counter-contact element 40 with the interposition of the backing film 26 and the protective coating 30 disposed thereon (see FIGS. 3 and 5). The counter-contact element 40 is sleeve-shaped in the case at hand. According to FIGS. 7 and 8, the counter-contact element 40 has an internal thread 44 on the inside of the sleeve, which can be engaged with an external thread 46 provided on at least part of an outer wall surface of the connection contact portion 38 in order to effect the counter-securing.

The counter-contact element 40 preferably has a shoulder girdle or a contact shoulder facing in the direction of the backing film 26 so as to counter-secure the backing film 26 and the protective coating 30 relative to the film contact portion 36 (see FIGS. 7 and 8). The shoulder girdle or the contact shoulder protrudes relative to a remaining outer periphery of the counter-contact element 40. The film contact portion 36 preferably comprises a contact shoulder which protrudes radially relative to an outer circumference of the connection contact portion (see FIGS. 3 to 6).

In the case at hand, the push-through contacting element 34 has the shape of a hollow rivet. The film contact portion 36 forms a rivet head. The connection contact portion 38 forms a tubular rivet shank (see FIGS. 7 and 8).

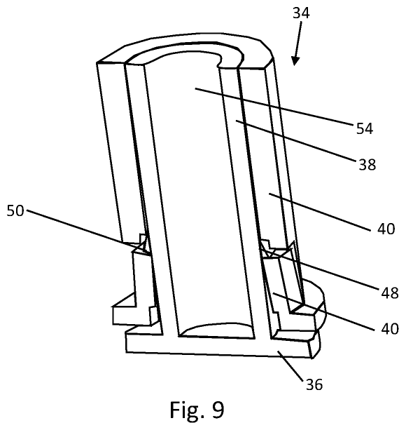

According to FIG. 9, the connection contact portion 38 comprises at least one catch web 48 on the outside. The counter-contact element 40 comprises a catch shoulder 50 corresponding to the catch web 48 on the inside, by means of which the counter-contact element 40 is counter-secured to the connection contact portion 38. In principle, an additional counter-contact element can also be provided, which can be screwed onto a portion of the connection contact portion 38 in order to counter-secure the other counter-contact element 40 and thus protect it from being lost, for example.

The connection contact portion 38 is configured to be connected to a terminal 52 of an electrical power source (not shown) (see schematic FIGS. 3 to 6). Preferably, an inner wall 54 of the tubular connection contact portion 38 is configured to accommodate the terminal 52 of the electrical power source. For this purpose, a terminal head 56, in particular a plug head, is preferably designed to complement a sleeve interior of the connection contact portion 38. For example, the terminal head 56 is designed as a compression spring head.

1. A heating mechanism for a cover element of a sensor assembly, the heating mechanism comprising:
a plurality of electrically connected conductor paths applied to a backing film and/or a heating film applied to the backing film,
wherein the heating mechanism comprises at least one electrical push-through contacting element, which has a film contact portion and a connection contact portion, and
a counter-contact element, the film contact portion being electro-conductively connected to at least one of the plurality of conductor paths and/or the heating film,
the connection contact portion insertable through the backing film and protruding relative to the backing film, and
the counter-contact element attachable to the connection contact portion in such a manner that the film contact portion is counter-secured relative to the counter-contact element with at least the backing film interposed, and
the connection contact portion being configured to be connected to a terminal of an electrical power source.

2. The heating mechanism according to claim 1, wherein the film contact portion is indirectly electro-conductively connected to the plurality of conductor paths and/or the heating film with an electrical contacting surface interposed.

3. The heating mechanism according to claim 1, wherein the push-through contacting element has the shape of a hollow rivet, the film contact portion forms a rivet head, and the connection contact portion forms a tubular rivet shank, an inner wall of the tubular connection contact portion configured to accommodate a terminal of an electrical power source.

4. The heating mechanism according to claim 1, wherein an outer diameter of the film contact portion is greater than an outer diameter of the connection contact portion.

5. The heating mechanism according to claim 1, wherein the counter-contact element is screwed and/or hooked and/or snap-locked and/or clamped to the connection contact portion.

6. The heating mechanism according to claim 1, wherein the counter-contact element is sleeve-shaped and/or tubular.

7. The heating mechanism according to claim 6,
wherein at least part of the connection contact portion comprises an external thread and at least part of the counter-contact element comprises an internal thread corresponding to the external thread, and
the counter-contact element is screwed onto the connection contact portion in such a manner than an annular sleeve edge of the counter-contact element is in contact with the backing film or with a cover layer applied to the backing film.

8. The heating mechanism according to claim 1,
wherein the connection contact portion comprises at least one catch groove and/or one catch web on the outside, and
the counter-contact element comprises a catch web corresponding to the catch groove and/or a catch groove and/or a catch shoulder corresponding to the catch web on the inside, via which the counter-contact element is counter-secured to the connection contact portion.

9. The heating mechanism according to claim 1, wherein the connection contact portion comprises at least one catch groove and/or a guide groove and/or a catch web and/or a guide web on the inside, which is/are configured to be brought into engagement with a terminal of an electrical power source.

10. A sensor assembly of a motor vehicle, the sensor assembly comprising:
a sensor element configured to emit and/or detect electromagnetic radiation in at least one measuring direction to obtain a measuring signal,
a cover element disposed in front of the sensor element in the at least one measuring direction and transparent to the electromagnet radiation, and
a heating mechanism according to claim 1, which is disposed on the cover element or integrated in the cover element.

11. The sensor assembly according to claim 10, wherein the cover element is made of plastic, or glass, and/or the backing film comprises a polycarbonate material.

12. The sensor assembly according to claim 10, wherein the cover element is an outer skin element of a vehicle roof.

13. The sensor assembly according to claim 10, wherein the cover element is an outer skin element of a vehicle front or a vehicle rear.

14. A roof module for forming a vehicle roof on a motor vehicle, the roof module comprising:
a panel component, which at least partially forms a roof skin of the vehicle roof, the roof skin serving as an outer sealing surface of the roof module, and
at least one sensor assembly according to claim 10.

15. A motor vehicle comprising:
a vehicle body,
a sensor assembly
the sensor assembly comprising:
a sensor element configured to emit and/or detect electromagnetic radiation in at least one measuring direction to obtain a measuring signal,
a cover element disposed in front of the sensor element in the at least one measuring direction and transparent to the electromagnet radiation, and a heating mechanism having a plurality of electrically connected conductor paths applied to a backing film and/or a heating film applied to the backing film,
wherein the heating mechanism comprises at least one electrical push-through contacting element, which has a film contact portion and a connection contact portion, and
a counter-contact element, the film contact portion being electro-conductively connected to at least one of the plurality of conductor paths and/or the heating film,
the connection contact portion insertable through the backing film and protruding relative to the backing film, and
the counter-contact element attachable to the connection contact portion in such a manner that the film contact portion is counter-secured relative to the counter-contact element with at least the backing film interposed, and
the connection contact portion being configured to be connected to a terminal of an electrical power source,
wherein the heating element is disposed on the cover element or integrated in the cover element,
wherein sensory assembly the cover element is an outer skin element of a vehicle roof,
or
a roof module comprising a panel component, which at least partially forms a roof skin of the vehicle roof, the roof skin serving as an outer sealing surface of the roof module, and at least one sensor assembly,
wherein the sensory assembly is disposed on the vehicle body as a structural unit, and
an electrical power source, which comprises at least one electrical terminal electro-conductively connected to the connection contact portion of the heating mechanism, the terminal preferably being a plug connector, which engages the connection contact portion to electrically connect the heating mechanism to the power source.

16. The heating mechanism according to claim 2, wherein the electrical contacting surface is a bus bar contacting surface.

17. The sensor assembly according to claim 11, wherein the plastic is a polycarbonate plastic.

18. The motor vehicle of claim 15, wherein the electrical power source is a vehicle battery.

19. The motor vehicle of claim 15, wherein the plug connector has a spring-loaded head.
